(19) United States
(12) Patent Application Publication
(10) Pub. No.: US 2026/0309642 A1
(43) Pub. Date: Oct. 8, 2026

(54) SPECTROSCOPIC BASED CONTAMINANT DETECTION SYSTEM

(71) Applicant: Sirish Subash, Sugar Hill, GA (US)

(72) Inventor: Sirish Subash, Sugar Hill, GA (US)

(21) Appl. No.: 19/172,814

(22) Filed: Apr. 8, 2025

(51) Int. Cl. G01N 21/94; G01N 21/47; G01N 21/88

(52) U.S. Cl. CPC G01N 21/94; G01N 21/4738; G01N 2021/8816; G01N 2201/0221; G01N 2201/06153

(57) ABSTRACT

A portable system including a detection unit and a controller is disclosed. The detection unit may illuminate a substrate for light spectroscopy, and capture light reflected by the substrate responsive to illuminating the substrate. The controller may obtain inputs from the detection unit, and determine a type of substrate based on the inputs. Responsive to determining the type of substrate, the processor may detect a presence of contaminant on the substrate, and output a notification on a user interface based on the detection. The controller may use one or more machine learning models to detect the presence of contaminant on the substrate.

### FIELD

The present disclosure relates to a contaminant detection system, and more specifically to a spectroscopic based contaminant detection system.

### BACKGROUND

Pesticide residue often remains on produce/substrate, even after washing the substrate multiple times. When such contaminated substrate is consumed regularly over long periods, exposure to pesticide residues may cause various health issues, including neurodegenerative diseases, cancer, etc.

There exist conventional systems and methods to detect the presence of pesticide residue/contaminants on the substrate. For instance, there exist colorimetric test strips that detect the presence of contaminants on substrates/food products. To detect the presence of contaminants, the conventional method includes the step of crushing or slicing the substrate to release internal and surface pesticide residues. The sample is then mixed with distilled water, and the test strip is dipped into the solution. When the strip changes color, it indicates the presence and concentration of pesticide residues.

While such strips are effective to some extent, they do not always provide accurate results. In addition, such testing method/system makes the substrate unfit for consumption after testing.

Thus, there exists a need for a system and method that accurately detects the presence of contaminants on a substrate, without making the substrate unfit for consumption.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a system to detect a presence of contaminant on a substrate, in accordance with the present disclosure.

FIG. 3 depicts an example process to detect a presence of contaminant on a substrate, in accordance with the present disclosure.

FIG. 4 depicts an exemplary user interface of a system in accordance with the present disclosure.

FIG. 5 depicts an exemplary waveform captured by the system in accordance with the present disclosure.

FIG. 6 depicts a flow diagram of an example method to detect a presence of contaminant on a substrate in accordance with the present disclosure.

### DETAILED DESCRIPTION

### Overview

The present disclosure describes a system and method to detect a presence of contaminant (e.g., pesticide residue) on a substrate using light spectroscopy. The light spectroscopy leverages unique absorption and reflection properties of contaminants at specific wavelengths, which may accurately detect the contaminant presence on the substrate. The system illuminates the substrate, and captures the light reflected by the substrate. The system then analyzes the reflected light, and determines the contaminant presence based on the analysis of the reflected light. When the substrate includes the contaminant on a substrate skin (or the substrate's exterior surface), the light would be reflected differently than the light reflected from a substrate without any contaminant.

In addition, the light may reflect differently for different types of contaminants, which may enable the system to detect the type of contaminant that may be present on the substrate. Stated another way, the reflected light also varies between individual types of contaminants, which enables the detection of contaminant types.

In some aspects, the system may include a detection unit, a controller, and a user interface, which may be communicatively coupled with each other. The detection unit may include a plurality of plurality of Light Emitting Diodes (LEDs) that may illuminate the substrate for light spectroscopy. The LEDs may include, for example, a white LED, an Ultraviolet (UV) LED and an Infrared (IR) LED. The detection unit may further include a plurality of sensors that captures/measures the light reflected from the substrate, responsive to illumination of the substrate by the LEDs.

The controller may obtain the inputs from the detection unit and then detect the presence of contaminant on the substrate based on the obtained inputs. The inputs may include spectral data, which may include waveforms that may be captured/measured by the sensors. The waveforms represent intensity of light at different wavelengths, where the waveform's horizontal axis represents wavelength or frequency and the vertical axis represents intensity, allowing for the analysis of its spectral characteristics. An example process implemented by the controller to detect the contaminant presence is briefly described below.

The controller may first detect a substrate type based on the obtained inputs. For instance, the controller may first determine whether the substrate is an apple, a tomato, a spinach, and/or the like. Determining the substrate type is a crucial step as reflectivity of the contaminant is affected by the underlying substrate. Hence, the determination of the substrate type enables the controller to accurately determine the contaminant information. To determine the substrate type, the controller may obtain inputs from the detection unit (that includes the captured spectral data/waveforms), and fetch and execute instructions stored in a first machine learning model on the obtained inputs to determine the substrate type. The first machine learning model may be trained on a training data that includes a first set of samples/waveforms for a first food type (e.g., an apple, without pesticide residue), a second set of samples/waveforms for a second food type (e.g., a spinach, without pesticide residue), and/or the like. When the controller executes the instructions stored in the first machine learning model, the first machine learning model may compare the captured spectral data/waveforms against the waveforms for different substrates (that may be associated with the training data of the first machine learning model). Based on the comparison, the controller (via the first machine learning model) may detect the substrate type.

Responsive to determining the substrate type, the controller may detect the presence of contaminant on the substrate based on the inputs obtained from the detection unit. To detect the contaminant presence, the controller may obtain the inputs from the detection unit (that includes the captured spectral data/waveforms). The controller may further select one or more second machine learning models, from a plurality of machine learning models, based on the substrate type. Responsive to the selection of the second machine learning models, the controller may execute the instructions stored in the second machine learning models on the obtained inputs to determine the contaminant presence. The second machine learning models may be trained using samples/waveforms for the substrate (apple) with contaminants and samples/waveforms for the substrate without contaminants, which may enable the controller to detect the presence of contaminants on the substrate. In addition, the second machine learning models may be trained using samples/waveforms associated with different contaminants (e.g., contaminant A, contaminant B, etc., associated with the respective substrate), which may enable the controller to detect a type of contaminant on the substrate.

When the controller executes the instructions stored in the second machine learning models, the second machine learning models may compare the captured spectral data/waveforms with the waveforms for different contaminants (that are associated with the training data of the second machine learning models). Based on the comparison, the controller (via the second machine learning models) may detect the presence of contaminants on the substrate and the type of contaminants.

Based on the detection, the controller may output a notification for a user via the user interface. The notification may indicate whether the substrate is contaminated or not, and also the contaminant types (if the substrate is contaminated). For instance, when the controller detects the contaminant presence on the substrate, the notification may indicate “pesticide detected”, and may further indicate the contaminant types (e.g., the contaminant name) detected on the substrate.

In further aspects, the controller may obtain the inputs from the detection unit, and may determine additional characteristics associated the substrate based on the obtained inputs. For instance, the controller may determine the temperature, the humidity/dampness level, and/or the like associated with the substrate based on the obtained inputs. In some aspects, the controller may detect the contaminant presence on the substrate based on the additional characteristics, potentially enhancing the accuracy of detection under varying conditions.

The present disclosure discloses a system and method that uses light spectroscopy to detect the presence of contaminants on substrates. Since the system uses light spectroscopy, the system detects the contaminant presence without making the substrate unfit for consumption after testing. In addition, the system is portable, which facilitates the user to detect the contaminant presence at home, supermarket, and/or the like. Further, the system uses machine learning models to detect the presence of contaminants (including the type of contaminants) accurately and efficiently.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

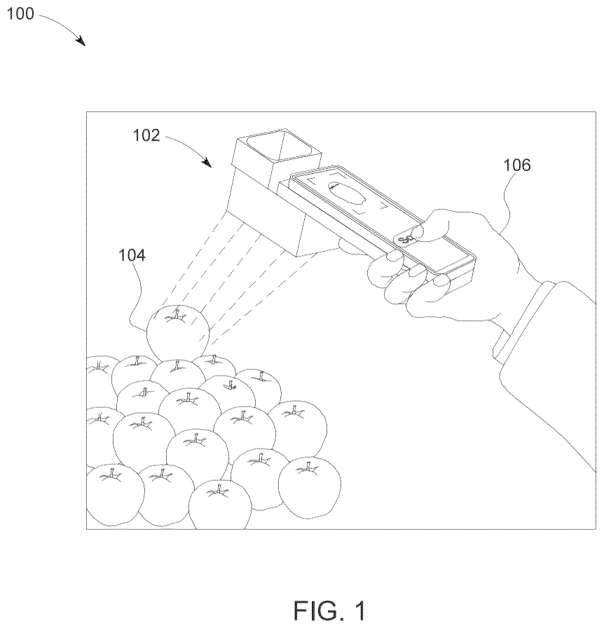

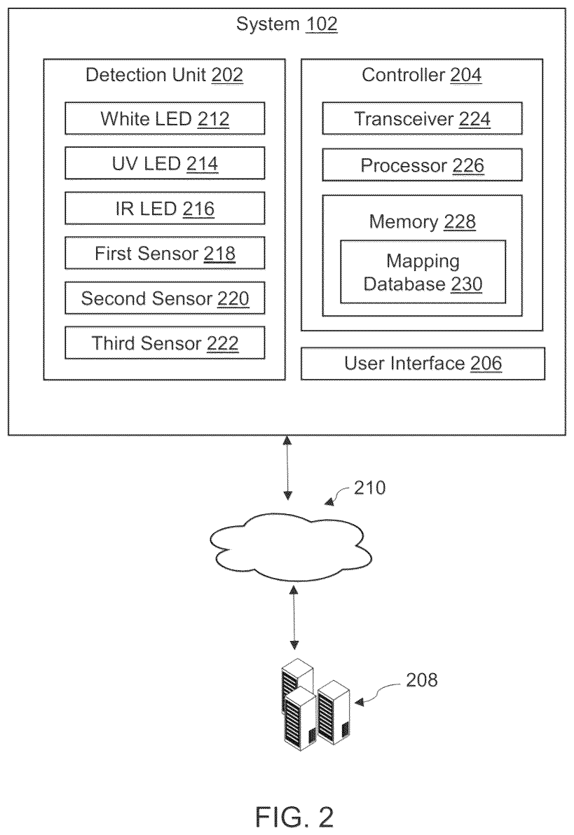

FIG. 1 depicts an environment 100 in which techniques and structures for providing the systems and methods disclosed herein may be implemented. FIG. 1 will be described in conjunction with FIGS. 2, 3, 4, and 5.

The environment 100 may include a portable contaminant detection system 102 (or system 102) that may detect pesticide residue or other contaminants (hereinafter referred to as “contaminant”) that may be present on a skin or exterior surface of a substrate 104. The substrate 104 may be, for example, a fruit (e.g., apple, strawberry, etc.), a vegetable (e.g., spinach, tomato, etc.), and/or the like. Although the present disclosure describes fruits and vegetables as the substrate 104, however, such description should not be construed as limiting the applicability of the disclosure to only fruits and vegetables. In some aspects, the substrate 104 may be water or any other fluid as well.

In some aspects, the system 102 may detect the contaminant presence on the substrate 104 by using light spectroscopy. Light spectroscopy is a non-destruction detection method that may facilitate in detecting contaminants without making the substrate 104 unfit for consumption after testing. Light spectroscopy leverages unique absorption and reflection properties of contaminants at specific wavelengths, to facilitate in accurate detection of contaminants on a surface/substrate. The system 102 captures the light reflected by the substrate 104, analyzes the reflected light, and determines the contaminant presence based on the analysis of the reflected light. When the substrate 104 includes a contaminant on the exterior surface, the light is reflected differently than the lights that gets reflected from a substrate without any contaminant. The system 102 uses this property of reflected light to detect the contaminant presence on the substrate 104.

In addition, for different contaminants, the light may reflect differently, which may enable the system 102 to detect the type of contaminant that may be present on the substrate 104. Stated another way, the reflected light also varies based on individual types of contaminants, which enables the system to detect the type of contaminant that may be present on the substrate 104. For instance, the system 102 may detect whether the substrate 104 includes, for example, acetamiprid, carbendazim, pyraclostrobin, tebuconazole, cyantraniliprole, permethrin, imidacloprid, etc., based on the light reflected from the substrate 104.

A user 106 may hold the system 102 in the user's hands, and detect the presence of contaminants on the substrate 104 via the system 102. The system 102 may act as a scanner that may scan the substrate's exterior surface for the presence of contaminants. The user 106 may hold the system 102 in proximity to the substrate 104 and may trigger the system 102 to scan the substrate 104 and determine if the substrate 104 has one or more contaminants. The user 106 may use the system 102 at home, in a supermarket, or any other place as the system 102 is portable.

The system 102 may include a plurality of components including, but not limited to, a detection unit 202, a controller 204 and a user interface 206 (as shown in FIG. 2). In some aspects, the system 102 may be communicatively coupled to a server 208, via one or more networks 210. The network(s) 210, as described herein, illustrates an example communication infrastructure in which the connected devices discussed in various embodiments of this disclosure may communicate. The network(s) 210 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The detection unit 202 may illuminate the substrate 104 (e.g., to perform light spectroscopy) and capture the light reflected by the substrate 104, responsive to illuminating the substrate 104. The detection unit 202 may include a plurality of plurality of Light Emitting Diodes (LEDs) that may illuminate the substrate 104 for light spectroscopy. The LEDs may include, for example, a white LED 212, an Ultraviolet (UV) LED 214 and an Infrared (IR) LED 216. The white LED 212 may emit broad-spectrum visible light having a first wavelength range (e.g., between 400-700 nm). The UV LED 214 may emit UV light having a second wavelength range (e.g., between 365-405 nm), and the IR LED 216 may emit IR light in a third wavelength range (e.g., between 700-1000 nm).

The detection unit 202 may further include a plurality of sensors that may capture/measure the light reflected by the substrate 104, responsive to the illumination of the substrate 104 by the LEDs described above. The plurality of sensors may include, for example, a first sensor 218, a second sensor 220 and a third sensor 222. The first sensor 218 may detect/capture the visible light illuminated by the white LED 212, the second sensor 220 may detect/capture the UV light illuminated by the UV LED 214, and the third sensor 222 may detect/capture the IR light illuminated by the IR LED 216. The plurality of sensors may capture the light across a plurality of distinct spectral channels. In some aspects, the plurality of sensors may capture/measure the reflected light in 18 different channels (that captures 18 different frequencies of light).

Although the present disclosure describes that the sensors capture/measure the reflected light in 18 different channels, however, such description should not be construed as limiting. In other aspects, the sensors may capture/measure the reflected light in more than 18 channels. Similarly, the sensors may capture/measure the reflected light in less than 18 channels.

As described above, the system 102 may include the controller 204, which may be communicatively coupled to the detection unit 202. The controller 204 may obtain the inputs from the detection unit 202 and detect the presence of contaminant on the substrate 104 based on the obtained inputs. The controller 204 may include a plurality of components including, but not limited to, a transceiver 224, a processor 226 and a memory 228. The transceiver 224 may transmit/receive information/inputs/data to/from the detection unit 202, the server 208, and/or the like.

The processor 226 may be in communication with one or more memory devices in communication with the respective computing systems (e.g., the memory 228 and/or one or more external databases not shown in FIG. 1). The processor 226 may utilize the memory 228 to store programs in code and/or to store data for performing aspects in accordance with the disclosure. The memory 228 may be a non-transitory computer-readable medium or memory storing a contaminant detection program code. The memory 228 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some aspects, the memory 228 may include a plurality of databases including, but not limited to, a mapping database 230. The mapping database 230 may store a mapping of a plurality of different types of substrates with a plurality of machine learning models. In some aspects, the plurality of machine learning models may be stored on the server 208. Alternatively, the plurality of machine learning models may be stored on the memory 228.

In some aspects, the controller 204 (e.g., the processor 226) may use Machine Learning (ML) to detect the contaminant presence on the substrate 104. A person ordinarily skilled in the art may appreciate that machine learning is an application of Artificial Intelligence (AI) using which systems (e.g., the system 102) may have the ability to perform various tasks, e.g., detect the contaminant presence on the substrate 104. Machine learning focuses on the use of data and algorithms to imitate the way humans learn. In some aspects, the machine learning algorithms may be created to make classifications and/or predictions.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification.

In regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning.

In an exemplary aspect, the system 102 (e.g., the processor 226) may use a supervised machine learning model (e.g., Random Forest) for detecting the contaminant presence on the substrate 104, contamination types, and concentration of the contaminants. In some aspects, the processor 226 may use a plurality of machine learning models to detect the contaminant presence. In some aspects, the machine learning models may be stored on the server 208. In some aspects, the processor 226 may obtain/fetch the machine learning models from the server 208 and detect the contaminant presence by using the fetched machine learning models, or may run the machine learning models on the server 208 itself. Alternatively, the machine learning models may be stored in the memory 228. In this case, the processor 226 may obtain/fetch the machine learning models from the memory 228 and then detect the contaminant presence. The details of the process implemented by the processor 226 to detect the contaminant presence on the substrate 104 is provided below.

In operation, the processor 226 may first obtain a trigger signal from the user 106 to detect the contaminant presence on the substrate 104. For instance, the user 106 may position the system 102 in proximity to the substrate 104, and use the user interface 206 to provide the trigger signal to the processor 226. For example, the user 106 may press a button on the user interface 206 to provide the trigger signal to the processor 226. The trigger signal may act as an activation request for the processor 226.

Responsive to obtaining the trigger signal from the user 106, the processor 226 may activate the detection unit 202. Stated another way, responsive to obtaining the trigger signal from the user 106, the processor 226 may transmit an activation signal to the detection unit 202 to cause its activation. Responsive to obtaining the activation signal, the detection unit 202 may activate or turn-on all the LEDs including the white LED 212, the UV LED 214, and the IR LED 216 to illuminate the substrate 104. In some aspects, the detection unit 202 may activate or turn-on all the LEDs for a predefined time duration. Responsive to illuminating the substrate 104, the detection unit 202 may capture/measure the light reflected by the substrate 104 (via the first, second and third sensors 218, 220, 222) in all the distinct spectral channels described above. The detection unit 202 may then transmit the spectral inputs/data (e.g., the captured measured light reflected by the sensors 218, 220, 222) to the processor 226, via the transceiver 224. The spectral data may include waveforms that may be captured/measured by the first, second, third sensors 218, 220, 222. The waveforms represent intensity of light at different wavelengths, often displayed as a spectrum, where the waveform's horizontal axis represents wavelength or frequency and the vertical axis represents intensity, allowing for the analysis of its spectral characteristics.

The processor 226 may obtain the inputs/information (or the spectral data/waveforms) from the detection unit 202 and detect the contaminant presence based on the obtained inputs. Specifically, the processor 226 may first determine a type of the substrate 104 based on the obtained inputs. For instance, the processor 226 may detect whether the substrate 104 is an apple, a tomato, a spinach, and/or the like, based on the inputs obtained from the detection unit 202. In an exemplary aspect, to determine the substrate type, the processor 226 may fetch a first predefined machine learning model from the server 208 or the memory 228. Responsive to fetching the first machine learning model, the processor 226 may execute the instructions (or “first instructions”) stored in the first machine learning model on the obtained inputs to determine the substrate type. The first machine learning model may be a generic model that may use the light reflected from the substrate 104 in the visible spectrum to determine the substrate type. The first machine learning model may be trained on a training data that includes a first set of samples/waveforms for a first food type (e.g., an apple, without pesticide residue), a second set of samples/waveforms for a second food type (e.g., a spinach, without pesticide residue), and/or the like.

In some aspects, the processor 226 may execute the first instructions associated with the first machine learning model on the obtained inputs to determine the substrate type. Specifically, the processor 226 may obtain the inputs (or the captured spectral data/waveforms) from the detection unit 202, and execute the first instructions stored in first machine learning model. When the processor 226 executes the first instructions, the first machine learning model may compare the captured spectral data/waveforms with the waveforms for different substrates (that are associated with training data of the first machine learning model) for spectroscopic analysis. Based on the comparison (or matching of unique spectral signatures), the processor 226 (via the first machine learning model) may determine the substrate type, as each substrate may have a unique spectral signature.

In alternative aspects, the processor 226 may use any other method/system to determine the substrate type. Determining the substrate type is a crucial step as reflectivity of the contaminant is affected by the underlying substrate. Hence, the determination of the substrate type enables the processor 226 to accurately determine the contaminant information.

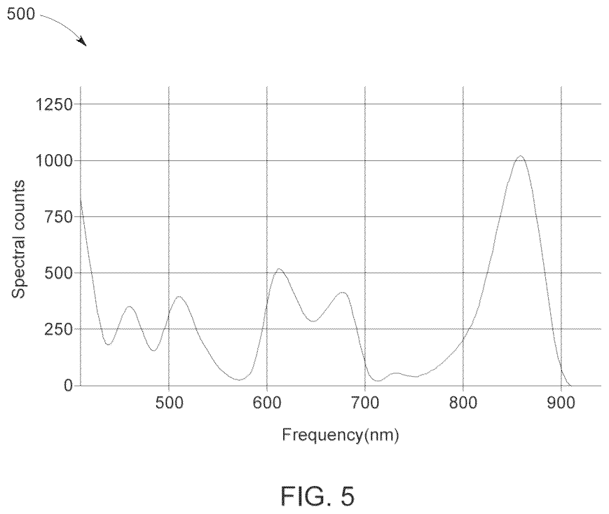

Responsive to executing the first instructions stored in the first machine learning model (or responsive to determining the substrate type), the processor 226 may detect the presence of contaminant on the substrate 104. To detect the contaminant presence, the processor 226 may select one or more second machine learning models, from the plurality of machine learning models stored in the server 208 or the memory 228, based on the substrate type. Stated another way, the processor 226 may select the second machine learning model(s) associated with the determined substrate type. For example, the processor 226 may select a first set of machine learning models “A” associated with apples, responsive to determining that the substrate 104 is an apple. Similarly, the processor 226 may select a second set of machine learning models “B” associated with oranges, responsive to determining that the substrate 104 is an orange, and so on. The second machine learning models may be trained using samples/waveforms for the substrate (apple) with contaminants and samples/waveforms for the substrate without any contaminants, which may enable the processor 226 to detect the presence of contaminants on the substrate 104. In addition, the second machine learning models may be trained using samples/waveforms associated with different contaminants (e.g., contaminant A, contaminant B, etc., associated with respective substrate), which may enable the processor 226 to detect a type of contaminant on the substrate 104. Each machine learning model, of the second machine learning models, may be associated with a specific contaminant. An example waveform/spectrum for a tomato with contaminant azoxystrobin is shown as waveform 500 in FIG. 5. The waveform 500 depicts photonic measurements/characteristics (e.g., spectral counts or intensity of light/radiation reflected by the substrate) at different frequencies when the substrate is tomato having the contaminant azoxystrobin. The waveform's horizontal axis (X-axis) represents frequency and the vertical axis (Y axis) represents the spectral count.

To select the second machine learning model(s), the processor 226 may fetch a mapping of a plurality of different types of substrates with the plurality of machine learning models from the memory 228 (e.g., from the mapping database 230). In this case, the mapping database 230 may store the mapping. Alternatively, the processor 226 may fetch the mapping from the server 208, via the network 210. Based on the fetched first mapping, the processor 226 may select the second machine learning model(s) associated with the determined substrate type. Responsive to selecting the second machine learning model(s), the processor 226 may execute the instructions (or “second instructions”) stored in the second machine learning model(s) on the inputs obtained from the detection unit 202 to detect the contaminant presence on the substrate 104.

When the controller executes the second instructions stored in the second machine learning models, the second machine learning models may compare the captured spectral data/waveforms with the waveforms that may be associated with the training data of the second machine learning models for spectroscopic analysis. Based on the comparison (or matching of unique spectral signatures), the processor 226 (via the second machine learning models) may detect the contaminant presence, as the substrate 104 with or without contaminants may have different spectral signatures.

Similarly, the second machine learning models may compare the captured spectral data/waveforms against the waveforms that may be associated with the training data of the second machine learning models to detect the type of contaminants, as each contaminant has a unique spectral signature. For instance, when the processor 226 detects that the substrate 104 is apple, the processor 226 may select the machine learning models associated with apple by using the mapping described above. Responsive to selecting the machine learning models associated with apple, the processor 226 may run all the machine learning models/classifiers (which includes a first machine learning model for contaminant A that may be present in apple, a second machine learning model for contaminant B that may be present in apple, and so on). Each machine learning model may output respective results. The processor 226 may obtain outputs from each machine learning model associated with apple, correlate the results of all machine learning models, and determine the contaminant type based on the correlation. For example, when the machine learning model associated with contaminant “A” indicates that the apple contains the contaminant “A” and the machine learning model associated with contaminant “B” indicates that the apple does not contain the contaminant “B”, the processor 226 may correlate the results and determine that the apple contains the contaminant “A”.

In some aspects, the processor 226 (via the second machine learning models) may determine a confidence level that indicates a probability that the substrate 104 is contaminated or not, based on the comparison/matching percentage. In some aspects, the processor 226 may determine the confidence value based on the correlation of the results of all the machine learning models described above. The processor 226 may compare the confidence value with a predefined threshold (e.g., 50%, 60%, 70%, and/or the like), and determine whether the substrate 104 has contaminants or not based on this comparison. For example, the processor 226 may determine that the substrate 104 is contaminated when the confidence value is more than 70%. In some aspects, when the confidence level is less than the predefined threshold, the processor 226 may perform the test/scan again.

In further aspects, responsive to determining that the substrate 104 may be contaminated (e.g., when the confidence level is greater than the predefined threshold), the processor 226 may use one or more machine learning models described above to determine a type of contaminant (e.g., a contaminant name) present on the substrate 104. An example process implemented by the processor 226 to determine the contaminant type(s) is described below.

Based on the contaminant detection, the processor 226 may output a notification for the user 106 via the user interface 206. The notification may indicate whether the substrate 104 is contaminated or not. For instance, when the processor 226 detects contaminant presence on the substrate 104, the notification may indicate “pesticide detected”, and may further indicate the contaminant type (e.g., the contaminant name) detected on the substrate 104. Alternatively or in addition, the system 102 may include a light indicator that may indicate the contaminant presence on the substrate 104. In this case, the light indicator may output a red light when the processor 226 detects the contaminant on the substrate 104, or may output a green light when the processor 226 does not detect any contaminant on the substrate 104.

In further aspects, the processor 226 may obtain the inputs from the detection unit 202 and determine additional characteristics associated the substrate 104 based on the obtained inputs. For instance, the processor 226 may determine the temperature, humidity/dampness, and/or the like associated with the substrate 104, based on the obtained inputs. For example, the processor 226 may determine whether the apple (that is scanned) is cold or at room temperature based on the obtained inputs. In some aspects, the processor 226 may use the inputs from the third sensor 222 (that captures the IR light illuminated by the IR LED 216) to determine the additional characteristics described above. In addition or alternatively, the system 102 may include one or more environmental sensors (e.g., temperature sensor, humidity sensor, etc.) that may detect the additional characteristics associated the substrate 104. It may be appreciated that the waveform associated with the substrate 104 may vary with different temperatures, humidity levels, etc.

Responsive to determining the additional characteristics, the processor 226 may detect the contaminant presence based on the additional characteristics. In some aspects, the processor 226 may incorporate the additional characteristics as inputs into the machine learning models that detect the contaminant presence and/or its type, potentially enhancing the accuracy under varying conditions. In some aspects, the machine learning models may be further trained on the training data that includes different sets of samples/waveforms at different temperatures/humidity levels, which may enable the processor 226 to detect the contaminant presence and/or its type accurately.

In some aspects, the detection unit 202, the controller 204, and the user interface 206 may be part of a single device. Stated another way, the system 102 may be a standalone device that may detect the contaminant presence (including the contaminant type(s)) by using the detection unit 202 and the controller 204, in the manner described above, and output the notification on the user interface 206 (that may be a display screen of the single device).

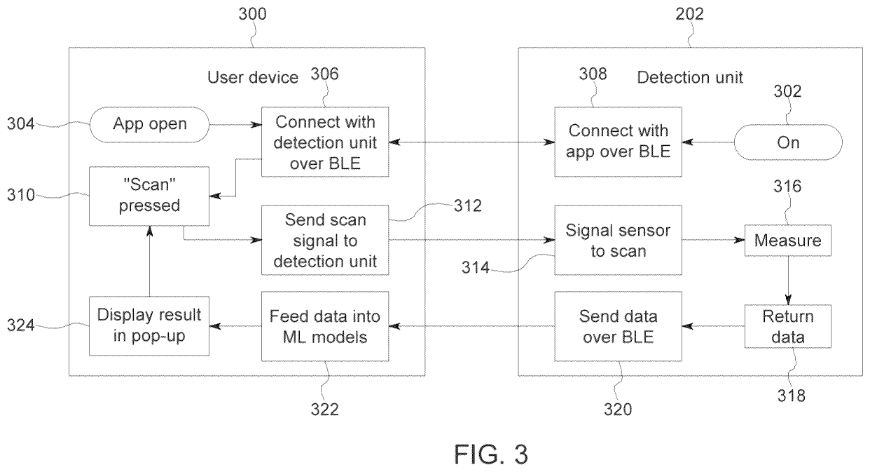

Alternatively, the system 102 may not be a standalone device, and the detection unit 202, the controller 204, and the user interface 206 may not be part of a single device. In this case, in an exemplary aspect, the controller 204 may be part of the server 208, which may communicatively couple with the detection unit 202, via the network 210. In such a scenario, a user device 300 (shown in FIG. 3) associated with the user 106 may access an application (or “app”, which may be hosted on the server 208) through which the user 106 may trigger the controller 204 to detect the contaminants on the substrate 104. The user device 300 may be, for example, a computer, a laptop, a mobile phone, a tablet, a smartwatch, or any other device with communication capabilities. The user device 300 may be communicatively coupled to the detection unit 202 (that may not be part of the user device 300), via the network 210. In an exemplary aspect, the user device 300 may be coupled to the detection unit 202 via BLE, and the detection unit 202 may be positioned in proximity to the user device 300. In such a scenario, the user interface 206 may be a part of the user device 300. In addition, in such scenarios, the detection unit 202 may include a local controller that may interface (and enable communication) with the controller 204. The local controller may include one or more components such as a transceiver, a processor and a memory (similar to the controller 204 described above). An exemplary process to detect the contaminant via the app (e.g., when the system 102 is not a standalone device) is described below.

In operation, the user 106 may turn-on or activate the detection unit 202, as shown in step 302 of FIG. 3. The user 106 may further open the “app” on the user device 300 when the user 106 desires to detect the presence of contaminant on the substrate 104, as shown in step 304. When the user 106 opens the app, the user device 300 may communicatively couple with the detection unit 202, via BLE, as shown in steps 306 and 308.

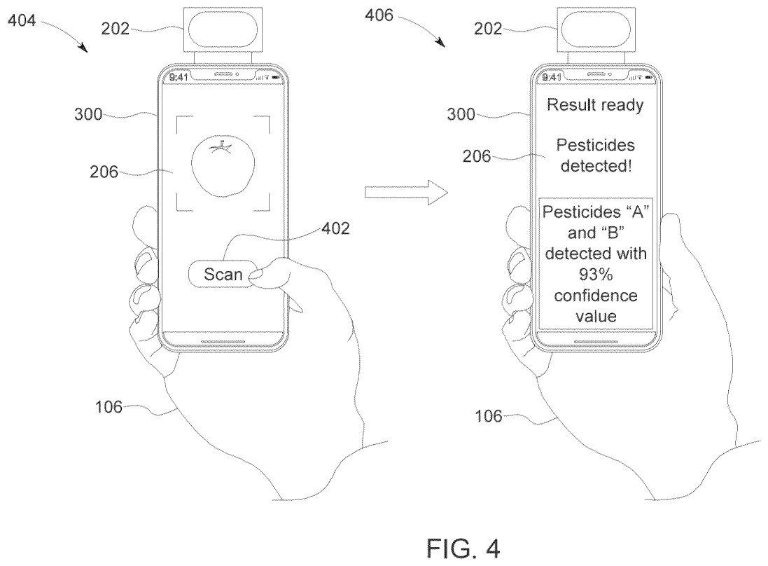

The user 106 may then position the system 102 (which, in this case, is the combination of the user device 300 and the detection unit 202) in proximity to the substrate 104. The user 106 may then use the user interface 206 associated with the user device 300 to provide the trigger signal to the processor 226 to scan the substrate 104. In some aspects, the user 106 may hold the system 102 such that the detection unit 202 may face the substrate 104 (to enable the detection unit 202 to illuminate the substrate 104 and capture the reflected light). The user 106 may then press a button (e.g., a scan button 402, shown in FIG. 4) on the user interface 206 to provide the trigger signal to the processor 226 (which is part of the user device 300 in this embodiment), as shown in a view 404 of FIG. 4 and step 310 in FIG. 3. In some aspects, the scan button 402 may appear on the user interface 206 when the user opens the app. Responsive to obtaining the trigger signal from the user 106, the processor 226 may transmit an activation signal (or a scan signal) to the detection unit 202, as shown in step 312.

Responsive to obtaining the activation signal, the detection unit 202 may activate the LEDs 212, 214, 216 and the sensors 218, 220, 222, to illuminate the substrate 104 and capture/measure the reflected light, as shown in step 314. The sensors 218, 220, 222 may measure the light reflected by the substrate 104 and return the spectral data associated with the reflected light to the local controller, as shown in steps 316 and 318. The local controller may obtain all the data from the sensors 218, 220, 222 and then transmit the spectral data to the controller 204 over BLE (or Bluetooth), Wi-Fi, or any other network(s) (e.g., the network(s) 210), as shown in step 320. In some aspects, the local controller may obtain multiple measurements from the sensors 218, 220, 222 to accurately detect the information associated with the contaminants.

The controller 204 may feed the spectral data into the machine learning models to detect the presence of contaminant and the contaminant type as described above, and as shown in step 322. The app may run the machine learning models. Stated another way, the raw data of 18 channels may be processed on the app side (or the server 208). The controller 204 may then output/display the notification on the user interface 206, as shown in step 324. An exemplary notification is shown in a view 406 of FIG. 4. The example notification indicates that the pesticides (or contaminants) are detected on the substrate 104. The notification further indicates that the pesticides “A” and “B” are detected with 93% confidence value.

In alternative aspect, the controller 204 may be part of the user device 300. In such scenarios, the machine learning models may run on the user device 300.

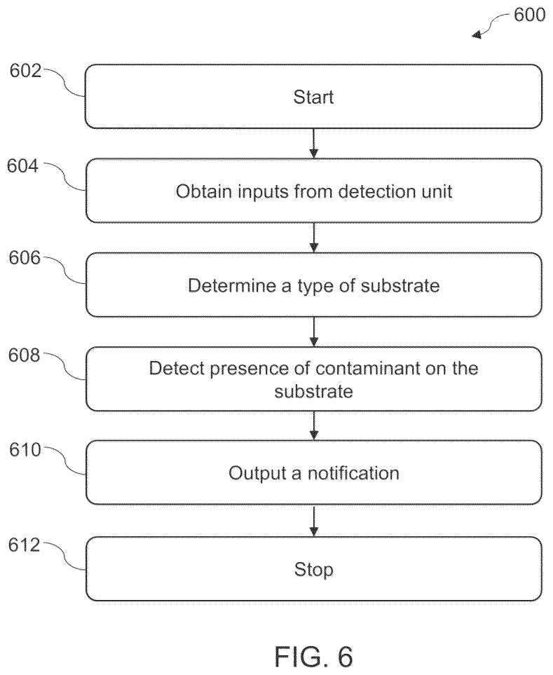

FIG. 6 depicts a flow diagram of an example method 600 to detect a presence of contaminant on a substrate in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include obtaining, by the processor 226, inputs from the detection unit 202. As described above, the detection unit 202 may illuminate the substrate 104 for light spectroscopy, and capture light reflected by the substrate 104 responsive to illuminating the substrate 104.

At step 606, the method 600 may include determining, by the processor 226, a type of substrate based on the inputs. At step 608, the method 600 may include detecting, by the processor 226, the presence of contaminant on the substrate 104 responsive to determining the type of substrate 104. At step 610, the method 600 may include outputting, by the processor 226, a notification on the user interface 206 based on the detection.

At step 612, the method 600 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A portable system comprising:
a detection unit configured to:
illuminate a substrate for light spectroscopy; and
capture light reflected by the substrate responsive to illuminating the substrate; and
a controller communicatively coupled to the detection unit, wherein the controller is configured to:
obtain inputs from the detection unit;
determine a type of substrate based on the inputs;
detect a presence of contaminant on the substrate responsive to determining the type of substrate; and
output a notification on a user interface based on the detection.

2. The portable system of claim 1, wherein the detection unit comprises a plurality of Light Emitting Diodes (LEDs) to illuminate the substrate, and wherein the plurality of LEDs comprises a white LED, an Ultraviolet (UV) LED, and an Infrared (IR) LED.

3. The portable system of claim 2, wherein the detection unit further comprises a plurality of sensors that captures the light reflected by the substrate.

4. The portable system of claim 3, wherein the plurality of sensors is configured to capture the light across a plurality of distinct spectral channels.

5. The portable system of claim 1, wherein the controller and the detection unit are part of a single device.

6. The portable system of claim 1, wherein the controller and the detection unit are parts of separate devices.

7. The portable system of claim 6, wherein the controller is part of a server that is communicatively coupled to a user device.

8. The portable system of claim 7, wherein the user device is communicatively coupled to the detection unit via Bluetooth or Wi-Fi.

9. The portable system of claim 7, wherein the controller is further configured to output the notification on the user device.

10. The portable system of claim 7, wherein the controller is further configured to:
obtain a trigger signal from a user via the user device; and
activate the detection unit responsive to obtaining the trigger signal.

11. The portable system of claim 1, wherein the controller is further configured to:
execute first instructions stored in a first machine learning model to determine the type of substrate;
select one or more second machine learning models, from a plurality of machine learning models, responsive to executing the first instructions stored in the first machine learning model; and
execute second instructions stored in the one or more second machine learning models to detect the presence of contaminant on the substrate.

12. The portable system of claim 11 further comprising a memory configured to store a mapping of the type of substrate and the plurality of machine learning models.

13. The portable system of claim 12, wherein the controller is further configured to:
obtain the mapping from the memory; and
select, responsive to determining the type of substrate, the one or more second machine learning models from the plurality of machine learning models based on the mapping and the type of substrate.

14. The portable system of claim 13, wherein the controller is further configured to execute second instructions stored in the one or more second machine learning models to determine a type of contaminant on the substrate.

15. The portable system of claim 14, wherein the notification indicates the type of contaminant on the substrate.

16. The portable system of claim 11, wherein the controller is further configured to:
determine additional characteristics of the substrate based on the inputs; and
detect the presence of contaminant on the substrate based on the additional characteristics.

17. The portable system of claim 16, wherein the additional characteristics comprise one or more of a substrate temperature or a substrate humidity.

18. A method comprising:
obtaining, by a controller, inputs from a detection unit, wherein the detection unit configured to:
illuminate a substrate for light spectroscopy; and
capture light reflected by the substrate responsive to illuminating the substrate;
determining, by the controller, a type of substrate based on the inputs;
detecting, by the controller, a presence of contaminant on the substrate responsive to determining the type of substrate; and
outputting, by the controller, a notification on a user interface based on the detection.

19. The method of claim 18 further comprising:
obtaining a trigger signal from a user via the user interface; and
activating the detection unit responsive to obtaining the trigger signal.

20. A non-transitory computer-readable storage medium having instructions stored thereupon which, when executed by a processor, cause the processor to:
obtain inputs from a detection unit, wherein the detection unit configured to:
illuminate a substrate for light spectroscopy; and
capture light reflected by the substrate responsive to illuminating the substrate;
determine a type of substrate based on the inputs;
detect a presence of contaminant on the substrate responsive to determining the type of substrate; and
output a notification on a user interface based on the detection.
